(19) United States
(12) Patent Application Publication
(10) Pub. No.: US 2025/0063053 A1
(43) Pub. Date: Feb. 20, 2025

(54) FORMAL VERIFICATION APPARATUS, FORMAL VERIFICATION METHOD AND PROGRAM

(71) Applicant: NIPPON TELEGRAPH AND TELEPHONE CORPORATION, Tokyo (JP)

(72) Inventors: Misato NAKABAYASHI, Tokyo (JP); Tetsuya OKUDA, Tokyo (JP)

(73) Assignee: NIPPON TELEGRAPH AND TELEPHONE CORPORATION, Tokyo (JP)

(21) Appl. No.: 18/724,566

(22) PCT Filed: Jan. 7, 2022
(86) PCT No.: PCT/JP2022/000404

§ 371 Date: Jun. 26, 2024

(51) Int. Cl. H04L 9/40

(52) U.S. Cl. CPC H04L 63/12; H04L 63/062

(57) ABSTRACT

A formal verification apparatus includes: a protocol information acquisition unit configured to acquire protocol information including a system configuration including a client terminal having a virtual network; and a protocol verification unit configured to handle an attack on the virtual network as an attack by the client terminal, which is an unauthorized terminal, by formal verification that is performed based on the protocol information, and verifies safety of a protocol indicated in the protocol information.

### TECHNICAL FIELD

The present invention relates to a formal verification apparatus, a formal verification method, and a program.

### BACKGROUND ART

A technique for performing formal verification of a security protocol is known. For example, Non-Patent Literature 1 discloses ProVerif as a de facto standard of a formal verification tool for a cryptographic protocol, which is used for safety evaluation of a security protocol. In ProVerif, safety verification is performed on a model called the Dolev-Yao model (Non-Patent Literature 2), in which cryptographic primitives are idealized.

### CITATION LIST

### Non-Patent Literature

Non-Patent Literature 1: Blanchet, B. “Automatic verification of security protocols in the symbolic model: The verifier proVerif”, Foundations of security analysis and design VII, Springer, pp. 54-87 (2013).
Non-Patent Literature 2: Dolev, D. and Yao, A.: On the security of public key protocols, IEEE Transactions on information theory, Vol. 29, No. 2, pp. 198-208 (1983).

### SUMMARY OF INVENTION

### Technical Problem

When a web service is provided on the premise that a server-authenticated secure channel is used as in transport layer security (TLS), eavesdropping, falsification, or the like on a public communication channel is not taken into account. Therefore, it is necessary to perform verification assuming attacks other than network attacks, for example, an attack on a user authentication protocol, such as impersonation or the like by an unauthorized user. However, conventional formal verification assumes a network attacker who performs eavesdropping, falsification, or the like on a public communication channel, like the Dolev-Yao model, and thus there is a problem that it is difficult to perform verification assuming attacks other than network attacks.

The disclosed technique aims to facilitate formal verification against attacks other than network attacks.

### Solution to Problem

The disclosed technology is a formal verification apparatus including: a protocol information acquisition unit configured to acquire protocol information including a system configuration including a client terminal having a virtual network; and a protocol verification unit configured to handle an attack on the virtual network as an attack by the client terminal, which is an unauthorized terminal, by formal verification that is performed based on the protocol information, and verifies safety of a protocol indicated in the protocol information.

### Advantageous Effects of Invention

It is possible to facilitate formal verification against attacks other than network attacks.

### BRIEF DESCRIPTION OF DRAWINGS

FIG. 1 is a diagram illustrating a functional configuration example of a formal verification apparatus according to the present embodiment.

FIG. 2 is a flowchart illustrating an example of a flow of formal verification process according to the present embodiment.

FIG. 3 is a diagram illustrating an example of a system configuration included in protocol information according to the present embodiment.

FIG. 4 is a diagram illustrating a hardware configuration example of a computer.

### DESCRIPTION OF EMBODIMENTS

Hereinafter, an embodiment of the present invention (present embodiment) will be described with reference to the drawings. The embodiment described below is merely an example, and an embodiment to which the present invention is applied is not limited to the following embodiment.

### Outline of Present Embodiment

A formal verification apparatus according to the present embodiment is a device that acquires protocol information and verifies a protocol based on the acquired protocol information. The protocol information includes a system configuration including a client terminal having a virtual network.

### Functional Configuration Example of Formal Verification Apparatus According to Present Embodiment

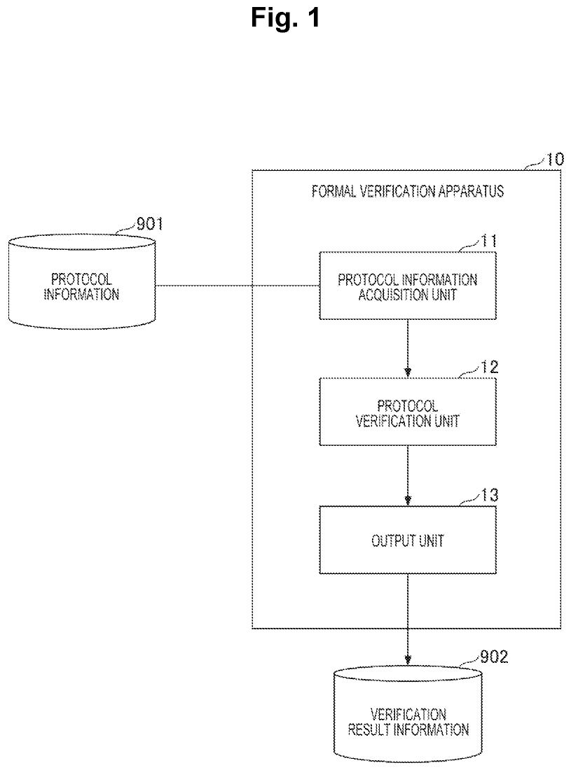

FIG. 1 is a diagram illustrating a functional configuration example of the formal verification apparatus according to the present embodiment. A formal verification apparatus 10 includes a protocol information acquisition unit 11, a protocol verification unit 12, and an output unit 13.

The protocol information acquisition unit 11 acquires protocol information 901. The protocol information 901 is information subject to formal verification. As described later, attacks other than network attacks are assumed, and thus the protocol information 901 is information indicating a protocol including a system configuration including a client terminal having a virtual network.

The protocol verification unit 12 verifies the safety of the protocol based on the protocol information 901. Specifically, the protocol verification unit 12 performs formal verification. The formal verification is to verify that a system is correct or, conversely, verify that a system is incorrect by using a formal method, mathematics, or the like and referring to description of formal technical specifications, a property, or the like. The protocol verification unit 12 handles an attack on the virtual network as an attack by a client terminal 100, which is an unauthorized terminal, by formal verification that is performed based on the protocol information 901, and verifies the safety of the protocol.

The output unit 13 outputs information indicating the verification result (verification result information 902). For example, the output unit 13 may display the verification result information 902 on a screen or the like, or may transmit the verification result information 902 to another device via a communication network or the like.

### Operation Example of Formal Verification Apparatus According to Present Embodiment

Next, the operation of the formal verification apparatus 10 will be described. The formal verification apparatus 10 executes formal verification process by a user operation or the like, or periodically.

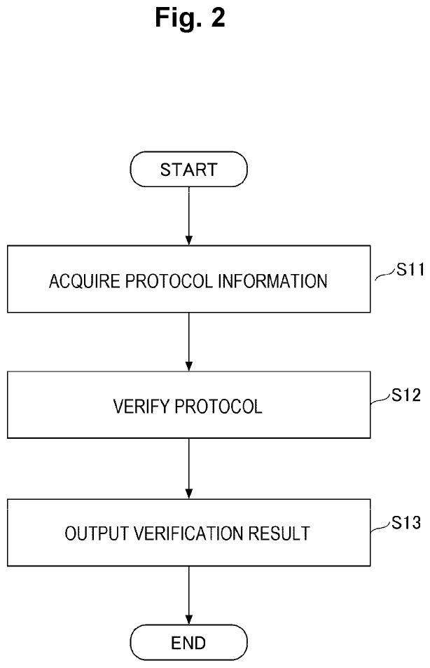

FIG. 2 is a flowchart illustrating an example of a flow of the formal verification process according to the present embodiment. The protocol information acquisition unit 11 acquires the protocol information 901 (step S11). Next, the protocol verification unit 12 verifies a protocol indicated in the protocol information 901 by formal verification (step S12). The output unit 13 then outputs the verification result (step S13).

### Example of System Configuration Included in Protocol Information

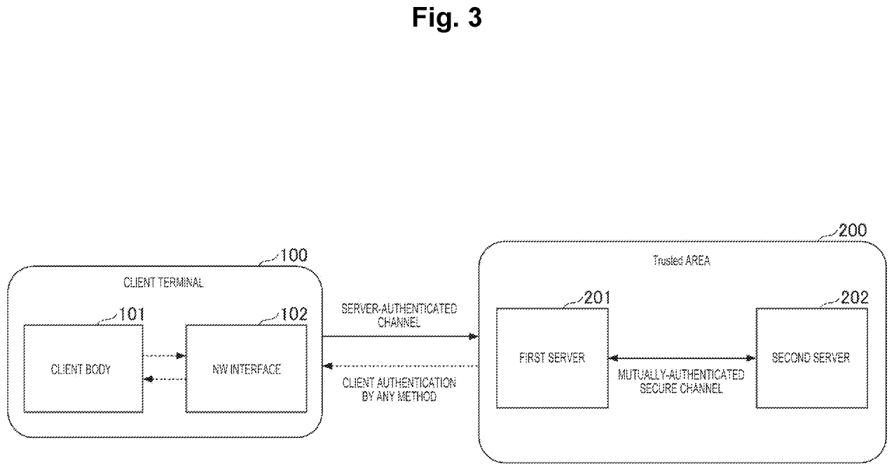

FIG. 3 is a diagram illustrating an example of the system configuration included in the protocol information according to the present embodiment. The system included in the protocol information 901 includes the client terminal 100, a first server 201, a second server 202, and the like. The first server 201 and the second server 202 are included in a trusted area 200.

The client terminal 100 includes a client body 101 and a NW interface 102. The NW interface 102 is an interface of a virtual public network included in the client terminal 100. Eavesdropping or falsification by a network attacker is enabled with the NW interface 102 as a starting point, and thus an unauthorized terminal can be represented.

In addition, in the protocol information 901, difficulty of eavesdropping or falsification of communication from another client terminal is formalized. Specifically, it is assumed that the another client terminal is authenticated and shares a pre-shared key with the first server 201 or the second server 202. As a result, the difficulty of eavesdropping or falsification of communication from the another client terminal is represented by encryption using a pre-shared key and a message authentication code (MAC). Note that client terminals may have client types such as: “authorized-new client”, “authorized-authenticated client”, and “attacker client”. In this case, processes other than that of an authorized-authenticated client need not be described in the protocol information 901.

Furthermore, in the protocol information 901, difficulty of impersonation or falsification in communication from the servers is formalized.

Specifically, the first server 201 and the second server 202 are connected via a mutually-authenticated secure channel. In addition, communication between the first server 201 or the second server 202 and the client terminal 100 is connected via a server-authenticated secure channel. Accordingly, it is assumed that communication from the first server 201 or the second server 202 to the client terminal 100 is communication in which impersonation, falsification, or the like cannot be performed. It may be assumed that a signature is added to all communications transmitted from the first server 201 or the second server 202. In addition, it may be assumed that a server public key is distributed by a public key infrastructure (PKI) for signature verification.

Furthermore, it is assumed that the unauthorized client terminal 100 can transmit an arbitrary request aiming to be accepted as an authorized client terminal to the first server 201 or the second server 202.

Note that safety requirements of user authentication in a web service in the present embodiment may be assumed as follows. For example, since secrecy of communication is protected by TLS, it may be assumed that there is no requirement for secrecy in an authentication protocol subjected to verification. In addition, as for a requirement for authentication, client authentication may be subjected to verification on the assumption of connection of an unauthorized client. Here, server authentication may be excluded from verification on the assumption that the server authentication has already been safely performed. In addition, mutual authentication in communication between the servers may be excluded from verification on the assumption that the mutual authentication has already been safely performed.

According to the formal verification apparatus 10 according to the present embodiment, it is possible to implement formal verification capable of detecting an attack such as impersonation on a user authentication protocol of a web service on the premise of TLS communication.

### Hardware Configuration Example According to Present Embodiment

The formal verification apparatus 10 can be implemented, for example, by causing a computer to execute a program in which process contents described in the present embodiment are described. Note that the “computer” may be a physical machine or a virtual machine on a cloud. In case a virtual machine is used, “hardware” to be described herein is virtual hardware.

The above program can be stored and distributed by being recorded in a computer-readable recording medium (such as a portable memory). The program can also be provided through a network such as the Internet or electronic mail.

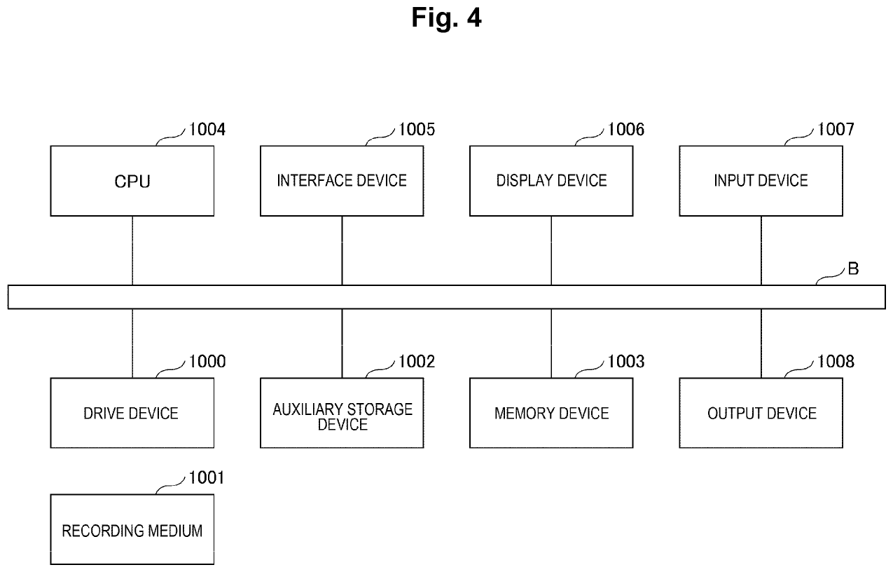

FIG. 4 is a diagram illustrating a hardware configuration example of the computer. The computer in FIG. 4 includes a drive device 1000, an auxiliary storage device 1002, a memory device 1003, a CPU 1004, an interface device 1005, a display device 1006, an input device 1007, an output device 1008, and the like, which are connected to each other by a bus B.

The program for implementing processes in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program does not necessarily have to be installed from the recording medium 1001, and may be downloaded from another computer via a network. The auxiliary storage device 1002 stores the installed program and also stores necessary files, data, and the like. When an instruction to start the program is made, the memory device 1003 reads the program from the auxiliary storage device 1002 and stores the program. The CPU 1004 implements a function related to the device in accordance with the program stored in the memory device 1003. The interface device 1005 is used as an interface for connection to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result. Note that the computer may include a graphics processing unit (GPU) or a tensor processing unit (TPU) instead of the CPU 1004, and may include the GPU or the TPU in addition to the CPU 1004. In this case, for example, the process may be shared and executed such that the GPU or the TPU executes process requiring special computation and the CPU 1004 executes other processes.

### Summary of Embodiment

The present specification describes at least a formal verification apparatus, a formal verification method, and a program described in the following clauses.
(Clause 1)
A formal verification apparatus including:
   a protocol information acquisition unit configured to acquire protocol information including a system configuration including a client terminal having a virtual network; and a protocol verification unit configured to handle an attack on the virtual network as an attack by the client terminal, which is an unauthorized terminal, by formal verification that is performed based on the protocol information, and verifies safety of a protocol indicated in the protocol information.
(Clause 2)
The formal verification apparatus according to clause 1, wherein
   it is assumed that, in the protocol information, a client terminal other than the client terminal included in the system configuration is authenticated and shares a pre-shared key with a server.
(Clause 3)
The formal verification apparatus according to clause 1 or 2, wherein
it is assumed that, in the protocol information, a plurality of servers included in the system configuration is connected via a mutually-authenticated secure channel.
(Clause 4)
A formal verification method executed by a formal verification apparatus, the formal verification method including:
   a step of acquiring protocol information including a system configuration including a client terminal having a virtual network; and
   a step of handling an attack on the virtual network as an attack by the client terminal, which is an unauthorized terminal, by formal verification that is performed based on the protocol information, and verifying safety of a protocol indicated in the protocol information.
(Clause 5)
A program for causing a computer to function as each unit in the formal verification apparatus according to any one of clauses 1 to 3.

Any of the above configurations provides a technique that can facilitate formal verification against attacks other than network attacks. According to clause 2, it is possible to formalize difficulty of eavesdropping or falsification of communication from another client terminal. According to clause 3, it is possible to formalize difficulty of impersonation or falsification in communication from a server.

Although the present embodiment has been described above, the present invention is not limited to such a specific embodiment, and various modifications and changes can be made within the scope of the gist of the present invention described in the claims.

### REFERENCE SIGNS LIST

10 Formal verification apparatus
11 Protocol information acquisition unit
12 Protocol verification unit
13 Output unit
100 Client terminal
200 Trusted area
201 First server
202 Second server
901 Protocol information
902 Verification result information
1000 Drive device
1001 Recording medium
1002 Auxiliary storage device
1003 Memory device
1004 CPU
1005 Interface device
1006 Display device
1007 Input device
1008 Output device

1. A formal verification apparatus comprising:
a protocol information acquisition unit configured to acquire protocol information including a system configuration including a client terminal having a virtual network; and
a protocol verification unit configured to handle an attack on the virtual network as an attack by the client terminal, which is an unauthorized terminal, by formal verification that is performed based on the protocol information, and verifies safety of a protocol indicated in the protocol information.

2. The formal verification apparatus according to claim 1, wherein
it is assumed that, in the protocol information, a client terminal other than the client terminal included in the system configuration is authenticated and shares a pre-shared key with a server.

3. The formal verification apparatus according to claim 1, wherein
it is assumed that, in the protocol information, a plurality of servers included in the system configuration is connected via a mutually-authenticated secure channel.

4. A formal verification method executed by a formal verification apparatus, the formal verification method comprising:
acquiring protocol information including a system configuration including a client terminal having a virtual network; and
handling an attack on the virtual network as an attack by the client terminal, which is an unauthorized terminal, by formal verification that is performed based on the protocol information, and verifying safety of a protocol indicated in the protocol information.

5. A computer-readable non-transitory recording medium storing program that when executed on a computer, causes the computer to function as each unit in the formal verification apparatus of claim 1.
